(19) United States
(12) Patent Application Publication
(10) Pub. No.: US 2026/0233244 A1
(43) Pub. Date: Aug. 13, 2026

(54) REUSEABLE MECHANICAL MASKING TOOLS FOR PAINTING TWO-TONE VEHICLES

(71) Applicant: GM Global Technology Operations LLC, Detroit, MI (US)

(72) Inventors: Marcel James Isrow, Bruce Township, MI (US); Hua-Tzu Fan, Troy, MI (US); John Patrick Spicer, Plymouth, MI (US); Dalong Gao, Rochester, MI (US); David G. Trudell, Lake Orion, MI (US); Mark Perin, Royal Oak, MI (US); Maureen A. Taylor, Warren, MI (US)

(73) Assignee: GM Global Technology Operations LLC, Detroit, MI (US)

(21) Appl. No.: 19/049,893

(22) Filed: Feb. 10, 2025

(51) Int. Cl. B05B 12/22; B05B 13/00

(52) U.S. Cl. CPC B05B 12/22; B05B 13/00

(57) ABSTRACT

A method includes applying first paint having a first color to a part and curing the first paint. The method also includes robotically affixing a masking material to a mechanical mask tool, and robotically positioning the mechanical mask tool proximate to the part. The method further includes applying second paint having a second color different from the first color to the part, wherein the mechanical mask tool prevents the second paint from being applied to a portion of the part that is to have the first color. The method additionally includes robotically repositioning the mechanical mask tool away from the part, curing the second paint, and robotically removing the affixed masking material from the mechanical mask tool.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Vehicles that are painted with two different colors of paint (i.e., two-tone vehicles, which may also be called tutone vehicles) have a transition line that separates the two different paint colors. Conventionally, masking material (e.g., tape and plastic sheeting) is manually applied to the vehicle at the transition line after the first color has been painted and cured and before the second color is painted. The masking material prevents the second color from being applied to a portion of the vehicle that is to have the first color.

The present disclosure relates generally to reuseable mechanical masking tools for painting two-tone vehicles.

### SUMMARY

One aspect of the disclosure provides a system for painting a vehicle. The system includes data processing hardware, and memory hardware in communication with the data processing hardware and storing instructions that, when executed by the data processing hardware, cause the data processing hardware to perform operations. The operations include applying first paint having a first color to the vehicle and curing the first paint. The operations also include robotically affixing a masking material to a mechanical mask tool, robotically positioning the mechanical mask tool proximate to the vehicle, applying second paint having a second color different from the first color to the vehicle, wherein the mechanical mask tool prevents the second paint from being applied to a portion of the vehicle that is to have the first color, and robotically repositioning the mechanical mask tool away from the vehicle. The operations further include curing the second paint, and robotically removing the affixed masking material from the mechanical mask tool.

Implementations of the disclosure may include one or more of the following optional features. In some implementations, affixing the masking material to the mechanical mask tool includes applying tape to a portion of the mechanical mask tool. Applying the tape to the portion of the mechanical mask tool may include unspooling the tape from a spool of unused tape and using guides to apply the unspooled tape to the mechanical mask tool. Removing the affixed masking material from the mechanical mask tool may include removing the tape from the mechanical mask tool and spooling the removed tape onto a spool of used tape.

In some examples, affixing the masking material to the mechanical mask tool includes applying a plurality of layers of tape to the mechanical mask tool, and removing the affixed masking material from the mechanical mask tool includes removing a single layer of the plurality of layers of tape. In some implementations, each layer of the plurality of layers of tape includes one or more easy-pick tabs, and removing the single layer of the plurality of layers of tape includes using the one or more easy-pick tabs of the single layer to remove the single layer of the plurality of layers of tape. In some examples, each layer of the plurality of layers of tape includes one or more tape-breaking locations to facilitate removal of the single layer of the plurality of layers of tape using the one or more easy-pick tabs.

In some implementations, affixing the masking material to the mechanical mask tool includes applying a mastic to the mechanical mask tool, and curing the mastic. In some examples, applying the mastic to the mechanical mask tool includes applying the mastic to extend beyond an end of the mechanical mask tool to form a tab, and removing the affixed masking material includes removing the mastic using the tab.

In some examples, affixing the masking material to the mechanical mask tool includes using a vacuum to hold the masking material to the mechanical mask tool. In some implementations, the system also includes a first robot configured to position and re-position the mechanical mask tool, a second robot configured to affix the masking material and remove the affixed masking material, and a third robot configured to apply the first paint and the second paint.

Another aspect of the disclosure provides a method including applying first paint having a first color to a part, curing the first paint, robotically affixing a masking material to a mechanical mask tool, and robotically positioning the mechanical mask tool proximate to the part. The method also includes applying second paint having a second color different from the first color to the part, wherein the mechanical mask tool prevents the second paint from being applied to a portion of the part that is to have the first color, robotically repositioning the mechanical mask tool away from the part, and curing the second paint. The method further includes robotically removing the affixed masking material from the mechanical mask tool.

Implementations of the disclosure may include one or more of the following optional features. In some implementations, affixing the masking material to the mechanical mask tool includes applying tape to a portion of the mechanical mask tool. In some examples, applying the tape to the portion of the mechanical mask tool includes unspooling the tape from a spool of unused tape and using guides to apply the unspooled tape to the mechanical mask tool, and removing the affixed masking material from the mechanical mask tool includes removing the tape from the mechanical mask tool, and spooling the removed tape onto a spool of used tape.

In some examples, affixing the masking material to the mechanical mask tool includes applying a plurality of layers of tape to the mechanical mask tool, and removing the affixed masking material from the mechanical mask tool includes removing a single layer of the plurality of layers of tape. In some implementations, each layer of the plurality of layers of tape includes one or more easy-pick tabs, and removing the single layer of the plurality of layers of tape includes using the one or more easy-pick tabs of the single layer to remove the single layer of the plurality of layers of tape. Each layer of the plurality of layers of tape may include one or more tape-breaking locations to facilitate removal of the single layer of the plurality of layers of tape using the one or more easy-pick tabs.

In some implementations, affixing the masking material to the mechanical mask tool includes applying a mastic to the mechanical mask tool, forming a tab in the mastic, and curing the mastic. In some examples, affixing the masking material to the mechanical mask tool includes using a vacuum to hold the masking material to the mechanical mask tool.

Yet another aspect of the disclosure provides a system for painting a vehicle. The system includes data processing hardware, and memory hardware in communication with the data processing hardware and storing instructions that, when executed by the data processing hardware, cause the data processing hardware to perform operations. The operations include applying first paint having a first color to the vehicle and curing the first paint. The operations also include robotically positioning a mechanical mask tool proximate to the vehicle, the mechanical mask tool formed to have a precision-made shape and comprising a low surface energy material, applying second paint having a second color different from the first color to the vehicle, wherein the mechanical mask tool prevents the second paint from being applied to a portion of the vehicle that is to have the first color. The operations further include robotically repositioning the mechanical mask tool away from the vehicle and curing the second paint.

### BRIEF DESCRIPTION OF THE DRAWINGS

The drawings described herein are for illustrative purposes only of selected configurations and are not intended to limit the scope of the present disclosure.

FIG. 1 is a schematic view of an example painting system for painting two-tone vehicles.

FIG. 2 illustrates an example method of applying and removing masking material.

FIG. 3 illustrates another example method of applying and removing masking material.

FIG. 4 illustrates yet another example method of applying and removing masking material.

FIGS. 5A and 5B illustrate a further example method of applying and removing masking material.

FIGS. 6A and 6B illustrate a still further example method of applying and removing masking material.

FIG. 7 is a flow chart of an example arrangement of operations for a method of painting a two-tone vehicle.

FIG. 8 is a schematic view of an example computing device that may be used to implement the systems and methods described herein.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/ electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Vehicles that are painted with two different colors of paint (i.e., two-tone vehicles, which may also be called tutone vehicles) have a transition line that separates the two different paint colors. Conventionally, masking material (e.g., tape and plastic sheeting) is manually applied to the vehicle at the transition line after the first color has been painted and cured, before the second color is painted. The masking material prevents the second color from being applied to a portion of the vehicle that is to have the first color. However, manually masking a vehicle and then manually removing the masking material is labor and time intensive. Moreover, while reuseable mechanical masks have been used to paint two-tone vehicles, conventional reuseable mechanical masks require a cleaning process between each use. Therefore, there is a need for improved methods of painting a two-tone vehicle.

In disclosed implementations, for each two-tone vehicle to be painted, fresh protection or masking material is robotically applied to a reuseable mechanical mask tool before the mechanical mask tool is robotically positioned proximate to a vehicle for painting the second color. After the second color is painted and the mechanical mask tool is repositioned away from the vehicle, the protection or masking material is robotically removed from the mechanical mask tool, and fresh protection material is applied for the next use of the mechanical mask tool. The protection or masking material may be robotically applied to the mechanical mask tool where, for example, the mechanical mask tool will contact the vehicle. Among other advantages, disclosed implementations enable the two-tone painting of vehicles using an automated process.

While configurations are shown and described herein in connection with painting a vehicle with two or more colors (e.g., an automobile, a truck, an airplane, a train, a motorcycle, a drone, etc.), it should be understood that disclosed configurations may additionally, or alternatively, be used to paint any other device using two or more colors. Moreover, disclosed configurations may additionally, or alternatively, be used for masking while applying a single color of paint to a vehicle or any other device.

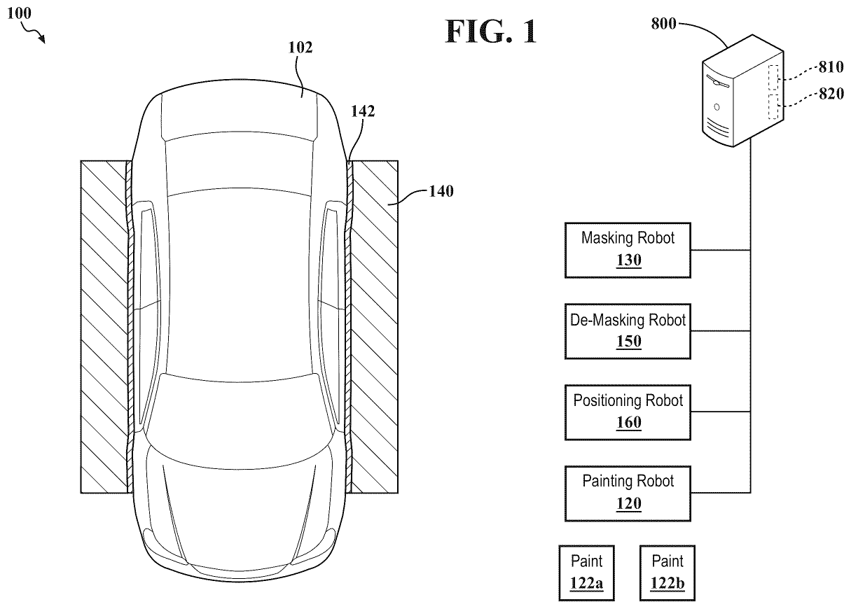

FIG. 1 is a schematic view of an example painting system 100 for painting a vehicle 102 (e.g., an automobile, a truck, an airplane, a train, a motorcycle, a drone, etc.) with two different colors of paint 122, 122a-b, that is, for painting a two-tone vehicle 102, which may also be referred to as a tutone vehicle 102. The painting system 100 may be implemented in a spray booth and/or as part of a manufacturing line. In some examples, a stop-station conveyer or moving line conveys the vehicle 102 into a vicinity of the painting system 100 for painting of the vehicle 102.

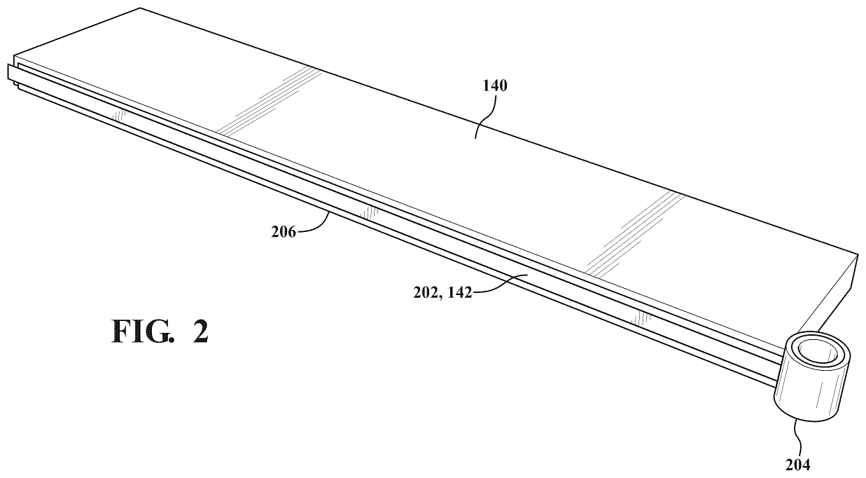

The painting system 100 includes a painting robot 120 configured and controlled to apply the paint 122 to the vehicle 102. In some examples, the painting robot 120 includes an atomizer paint applicator. The painting system 100 also includes a masking robot 130 configured and controlled to robotically affix a masking material 142 to a reusable mechanical mask tool 140, and a de-masking robot 150 configured and controlled to remove the masking material 142 from the mechanical mask tool 140 after the mechanical mask tool 140 has been used to paint the second color of paint 122 of a two-tone paint application. FIGS. 2-6 illustrate example methods of applying and removing masking material 142 to a mechanical mask tool 140. Here, the masking material 142 is applied to an area of the reusable mechanical masking tool 140 that will come into contact with the vehicle 102 to prevent previously applied paint 122 from coming into contact with the vehicle 102. In some implementations, the masking material 142 will help form a seal between the vehicle 102 and the reusable mechanical masking tool 140. Additionally, the masking material 142 may be applied to an area of the reusable mechanical masking tool 140 will be near to the vehicle 102 and/or to an area of the reusable mechanical masking tool 140 that may be prone to accumulating overspray.

The painting system 100 additionally includes a positioning robot 160 configured and controlled to position the mechanical mask tool 140 proximate to the vehicle 102 for painting the second color of paint 122 and, after the second color of paint 122 is painted, to reposition the mechanical mask tool 140 away from the vehicle 102. Here, the mechanical mask tool 140 prevents the second paint 122 from being applied to a portion of the vehicle 102 that is to have the first paint color.

While the robots 120, 130, 150, and 160 are shown separately in FIG. 1, the robots 120, 130, 150, and 160 may be combined into fewer robots. For example, a robot may be configured and controlled to both apply masking material 142 to, and remove masking material 142 from, the mechanical mask tool 140.

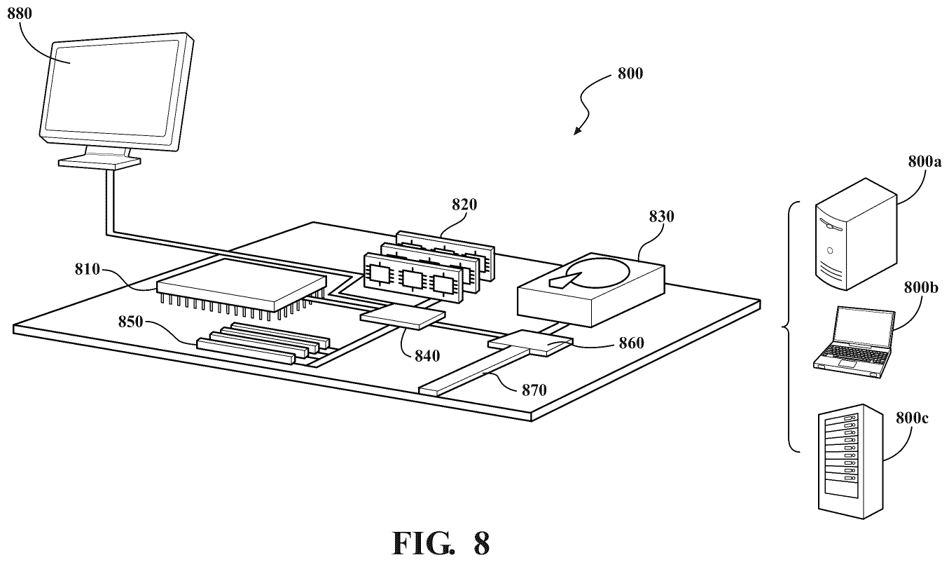

The painting system 100 also includes one or more computing systems 800 (see FIG. 8) for configuring and controlling the robots 120, 130, 150, and 160. In some examples, a computing system 800 configures and controls multiple robots 120, 130, 150, and 160. Alternatively, each robot 120, 130, 150, and 160 may be configured and controlled by a respective computing system 800. The computing system 800 may correspond to any type of computing device, such as a process controller. The computing system 800 includes data processing hardware 810, and memory hardware 820 in communication with the data processing hardware 810. Here, the memory hardware 820 stores instructions that, when executed by the data processing hardware 810, cause the data processing hardware 810 to perform one or more operations, such as those disclosed herein.

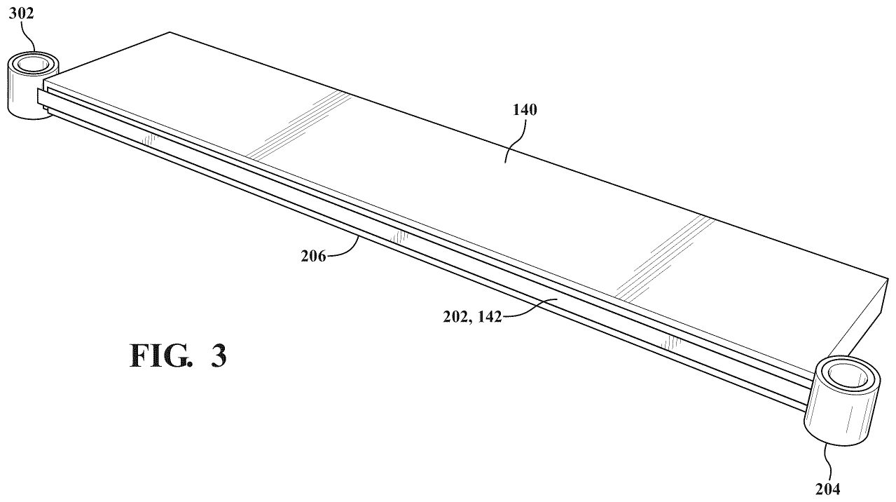

As shown in FIGS. 2 and 3, the masking material 142 may include tape 202 that is robotically applied or affixed to a portion (e.g., an edge) of the mechanical mask tool 140 by the masking robot 130. As shown, the tape 202 may be unspooled from a replaceable pre-loaded spool 204 of unused tape. In some implementations, the tape 202 is unspooled from the spool 204 and then moved into and/or pressed into contact with the mechanical mask tool 140. In some examples, a guide system 206 (e.g., a channel, rail or track) guides the position of the tape 202 as it is pulled across the mechanical mask tool 140 by, for example, the masking robot 130. In some implementations, the spool 204 of unused tape includes a plurality of individual pieces of the tape 202 that each includes a tab that may be used by the masking robot 130 to grab and pull the tape 202 from the spool 204. Alternatively, the spool 204 may be a continuous role of tape 202. Here, the de-masking robot 150 may cut the tape 202 to remove a used piece of tape 202.

As shown in FIG. 3, the de-masking robot 150 may remove the tape 202 (i.e., the masking material 142) by spooling the tape 202 onto a spool 302 of used tape. In some examples, the de-masking robot 150 turns the spool 302 (e.g., by energizing an electric or pneumatic motor) to remove the tape 202. The spool 302 may be disposable. In some implementations, turning the spool 302 both applies unused tape 202 to the mechanical mask tool 140 and removes used tape 202 from the mechanical mask tool 140. In some examples, the tape 202 has sufficient strength to avoid being torn when the spool 302 is turned to un-adhere the tape 202 from the mechanical mask tool 140. Additionally, or alternatively, the de-masking robot 150 may move the spool 204 and/or the spool 302 away from the mechanical mask tool 140 to first un-adhere the tape 202 from the mechanical mask tool 140 before the used tape 202 is spooled on the spool 302.

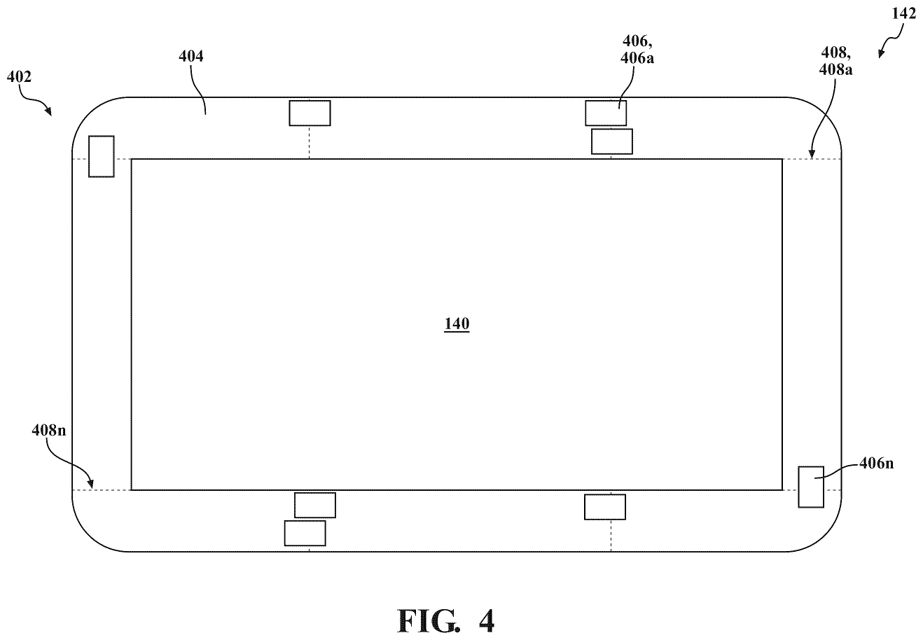

In the illustrated example of FIG. 4, the masking material 142 includes a plurality of layers of tape 402 that are applied as a group to the reusable mechanical mask tool 140 by, for example, the masking robot 130 or a human. Alternatively, the mechanical mask tool 140 may be pre-taped or pre-layered with the plurality of layers of tape 402. While the reusable mechanical mask tool 140 of FIG. 4 has a shape that is different from that shown in FIGS. 2 and 3, a plurality of layers of tape 402 could also be applied as a group to the reusable mechanical mask tool 140 of FIGS. 2 and 3. Here, the de-masking robot 150 may remove a single layer 404 (i.e., a top layer) of the plurality of layers to tape 402 after the mechanical mask tool 140 is used. As shown, each layer 404 of the plurality of layers of tape 402 may include one or more easy-pick tabs 406, 406a-n, such that a layer 404 can be removed by the de-masking robot 150 using the easy-pick tabs 406. In some examples, the easy-pick tabs 406 pop or spring up for easy grasping by the de-masking robot 150 when a previous layer 404 is removed. In some implementations, each layer 404 includes one or more tape-breaking locations 408, 408a-n to facilitate removal of the layer 408 by the de-masking robot 150 using the one or more easy-pick tabs 406.

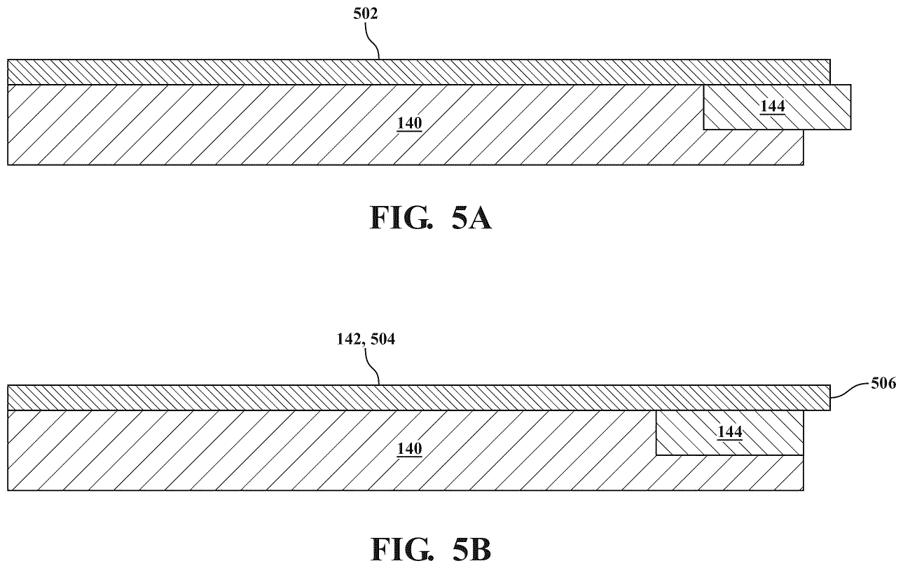

In the illustrated example of FIGS. 5A and 5B, the masking robot 130 applies the masking material 142 by applying an uncured mastic 502 to the mechanical mask tool 140 and cures the mastic 502 (e.g., using ultraviolet light) to form cured mastic 504 as the masking material 142. As shown, the uncured mastic 502 may be applied, using a retractable member 144 of the mechanical mask tool 140 or another structure, to extend beyond an end of the mechanical mask tool 140 to form a tab 506. Here, the de-masking robot 150 may grasp the tab 506 to remove the cured mastic 505 from the mechanical mask tool 140. In some examples, the retractable member 144 can be moved out from (see FIG. 5A) and then retract into (see FIG. 5B) the mechanical mask tool 140. Additionally, or alternatively, the member 144 may be an expandable member than can, for example, expand when air is blown into the member 144.

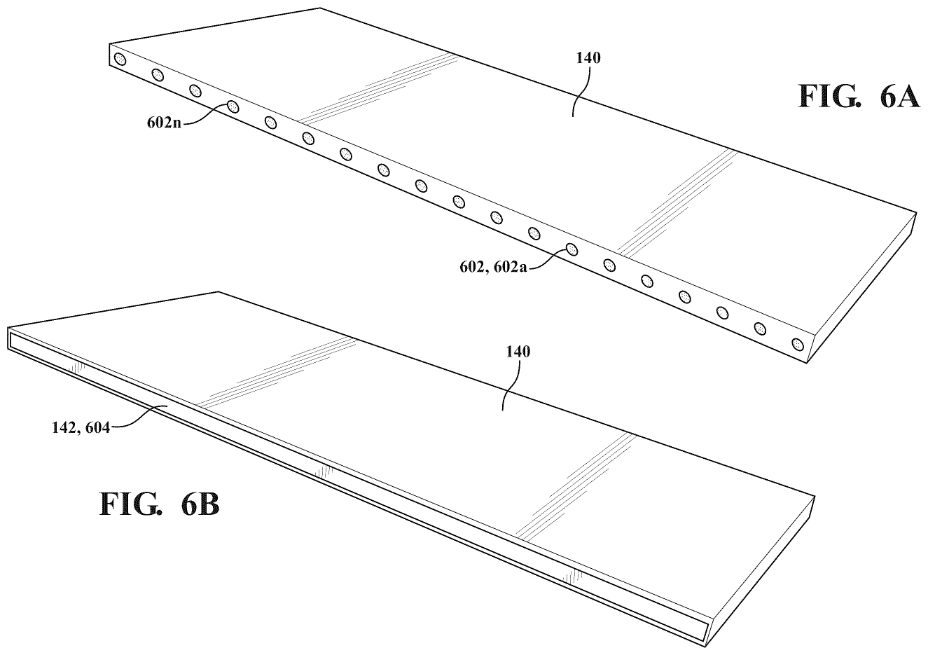

In the illustrated example of FIGS. 6A and 6B, the mechanical mask tool 140 includes a plurality of ports or openings 602, 602a-n such that a vacuum (not shown for clarity of illustration) may be used to hold mask material 142 (e.g., die-cut mask material 604) to the mechanical mask tool 140. Here, the masking robot 130 may place the mask material 604 in front of the ports or openings 602 and activate the vacuum to affix the mask material 604 to the mechanical mask tool 140. In some implementations, pressurized air may be passed through the ports of openings 602 (e.g., by the de-masking robot 150) to remove the mask material 604 from the mechanical mask tool 140.

In another example, the mechanical mask tool 140 is formed to have a precision-made or custom-fit shape using a low surface energy material (e.g., thermoplastic olefin (TPO)) such that paint 122 does not adhere to, or can be easily removed from, the mechanical mask tool 140 material. Here, the mechanical mask tool 140 is custom-fit or precision-made to precisely or substantially prevent paint 122 from being adhered to an area of a vehicle 102 that is to have a different color. After the paint 122 is cured, the mask 140 may be cleaned by removing second paint on the mask 140 from the mask 140, and reused to paint another vehicle 102.

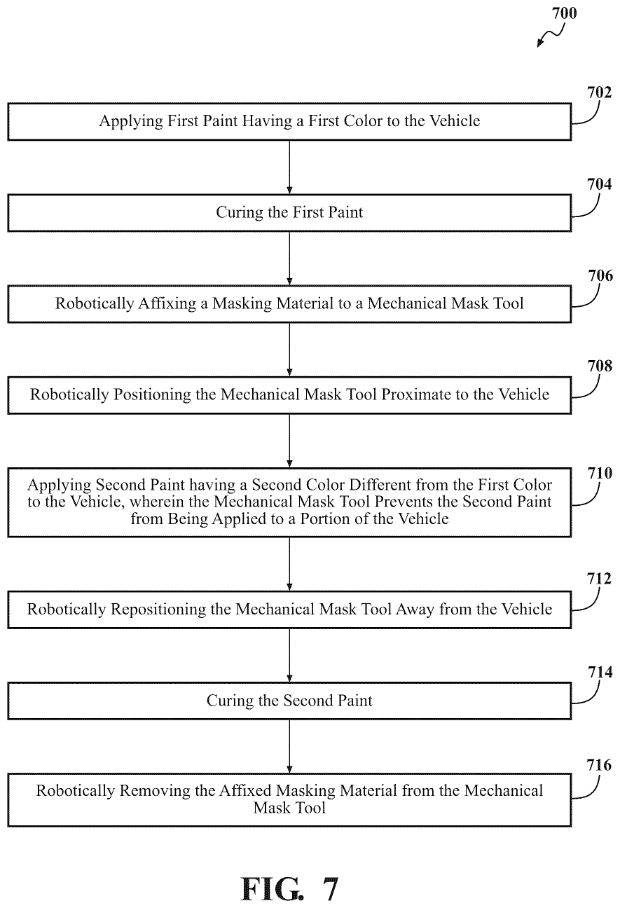

FIG. 7 is a flowchart of an exemplary arrangement of operations for a method 700 for painting a two-tone vehicle 102. The operations may be performed by data processing hardware (e.g., the data processing hardware 810 of FIG. 8) based on executing instructions stored on memory hardware (e.g., the memory hardware 820 of FIG. 8). Many other ways of implementing the method 700 may be employed. For example, the order of execution of the operations may be changed, and/or one or more of the operations and/or interactions may be changed, eliminated, sub-divided, or combined. Additionally, the operations of FIG. 7 may be carried out sequentially and/or in parallel by, for example, separate processing threads, processors, devices, discrete logic, circuits, etc.

At operation 702, the method 700 includes applying first paint 122 having a first color to the vehicle 102. At operation 704, the method 700 includes curing the first paint 122.

At operation 706, the method 700 includes robotically affixing a masking material 142 to a mechanical mask tool 140. At operation 708, the method 700 includes robotically positioning the mechanical mask tool 140 proximate to the vehicle 102. At operation 710, the method 700 includes applying second paint 122 having a second color different from the first color to the vehicle, wherein the mechanical mask tool 140 prevents the second paint 122 from being applied to a portion of the vehicle 102. At operation 712, the method 700 includes robotically repositioning the mechanical mask tool 140 away from the vehicle 102. At operation 714, the method 700 includes curing the second paint 122. In some implementations, after the mechanical mask tool 140 is repositioned away from the vehicle 102 at operation 712, the vehicle 102 is moved from a spray booth in which the second paint 122 was applied into a cure oven to cure second paint 122.

At operation 716, the method 700 includes robotically removing the affixed masking material 142 from the mechanical mask tool 140.

FIG. 8 is a schematic view of an example computing device 800 that may be used to implement the systems and methods described herein. The computing device 800 is intended to represent various forms of digital computers, such as controllers, laptops, desktops, workstations, servers, and other appropriate computers. The components shown here, their connections and relationships, and their functions, are meant to be exemplary only, and are not meant to limit implementations of the inventions described and/or claimed in this document.

The computing device 800 includes a processor 810 (i.e., data processing hardware), memory 820 (i.e., memory hardware), a storage device 830 (i.e., memory hardware), a high-speed interface/controller 840 connecting to the memory 820 and high-speed expansion ports 850, and a low-speed interface/controller 860 connecting to a low-speed bus 870 and a storage device 830. The components 810, 820, 830, 840, 850, and 860 are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high-speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 820, the storage device 830, or memory on processor 810.

The high-speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for painting a vehicle, the system comprising:
data processing hardware; and
memory hardware in communication with the data processing hardware and storing instructions that, when executed by the data processing hardware, cause the data processing hardware to perform operations comprising:
applying first paint having a first color to the vehicle;
curing the first paint;
robotically affixing a masking material to a mechanical mask tool;
robotically positioning the mechanical mask tool proximate to the vehicle;
applying second paint having a second color different from the first color to the vehicle, wherein the mechanical mask tool prevents the second paint from being applied to a portion of the vehicle that is to have the first color;
robotically repositioning the mechanical mask tool away from the vehicle;
curing the second paint; and
robotically removing the affixed masking material from the mechanical mask tool.

2. The system of claim 1, wherein affixing the masking material to the mechanical mask tool comprises applying tape to a portion of the mechanical mask tool.

3. The system of claim 2, wherein applying the tape to the portion of the mechanical mask tool comprises:
unspooling the tape from a spool of unused tape; and
using guides to apply the unspooled tape to the mechanical mask tool.

4. The system of claim 3, wherein removing the affixed masking material from the mechanical mask tool comprises:
removing the tape from the mechanical mask tool; and
spooling the removed tape onto a spool of used tape.

5. The system of claim 1, wherein:
affixing the masking material to the mechanical mask tool comprises applying a plurality of layers of tape to the mechanical mask tool; and
removing the affixed masking material from the mechanical mask tool comprises removing a single layer of the plurality of layers of tape.

6. The system of claim 5, wherein:
each layer of the plurality of layers of tape comprises one or more easy-pick tabs; and
removing the single layer of the plurality of layers of tape comprises using the one or more easy-pick tabs of the single layer to remove the single layer of the plurality of layers of tape.

7. The system of claim 6, wherein each layer of the plurality of layers of tape comprises one or more tape-breaking locations to facilitate removal of the single layer of the plurality of layers of tape using the one or more easy-pick tabs.

8. The system of claim 1, wherein affixing the masking material to the mechanical mask tool comprises:
applying a mastic to the mechanical mask tool; and
curing the mastic.

9. The system of claim 8, wherein:
applying the mastic to the mechanical mask tool comprises applying the mastic to extend beyond an end of the mechanical mask tool to form a tab; and
removing the affixed masking material comprises removing the mastic using the tab.

10. The system of claim 1, wherein affixing the masking material to the mechanical mask tool comprises using a vacuum to hold the masking material to the mechanical mask tool.

11. The system of claim 1, further comprising:
a first robot configured to position and re-position the mechanical mask tool;
a second robot configured to affix the masking material and remove the affixed masking material; and
a third robot configured to apply the first paint and the second paint.

12. A method comprising:
applying first paint having a first color to a part;
curing the first paint;
robotically affixing a masking material to a mechanical mask tool;
robotically positioning the mechanical mask tool proximate to the part;
applying second paint having a second color different from the first color to the part, wherein the mechanical mask tool prevents the second paint from being applied to a portion of the part that is to have the first color;
robotically repositioning the mechanical mask tool away from the part;
curing the second paint; and
robotically removing the affixed masking material from the mechanical mask tool.

13. The method of claim 12, wherein affixing the masking material to the mechanical mask tool comprises applying tape to a portion of the mechanical mask tool.

14. The method of claim 13, wherein:
applying the tape to the portion of the mechanical mask tool comprises:
unspooling the tape from a spool of unused tape; and
using guides to apply the unspooled tape to the mechanical mask tool; and
removing the affixed masking material from the mechanical mask tool comprises:
removing the tape from the mechanical mask tool; and
spooling the removed tape onto a spool of used tape.

15. The method of claim 12, wherein:
affixing the masking material to the mechanical mask tool comprises applying a plurality of layers of tape to the mechanical mask tool; and
removing the affixed masking material from the mechanical mask tool comprises removing a single layer of the plurality of layers of tape.

16. The method of claim 15, wherein:
each layer of the plurality of layers of tape comprises one or more easy-pick tabs; and
removing the single layer of the plurality of layers of tape comprises using the one or more easy-pick tabs of the single layer to remove the single layer of the plurality of layers of tape.

17. The method of claim 16, wherein each layer of the plurality of layers of tape comprises one or more tape-breaking locations to facilitate removal of the single layer of the plurality of layers of tape using the one or more easy-pick tabs.

18. The method of claim 12, wherein affixing the masking material to the mechanical mask tool comprises:
applying a mastic to the mechanical mask tool;
forming a tab in the mastic; and
curing the mastic.

19. The method of claim 12, wherein affixing the masking material to the mechanical mask tool comprises using a vacuum to hold the masking material to the mechanical mask tool.

20. A system for painting a vehicle, the system comprising:
data processing hardware; and
memory hardware in communication with the data processing hardware and storing instructions that, when executed by the data processing hardware, cause the data processing hardware to perform operations comprising:
applying first paint having a first color to the vehicle;
curing the first paint;
robotically positioning a mechanical mask tool proximate to the vehicle, the mechanical mask tool formed to have a precision-made shape and comprising a low surface energy material;
applying second paint having a second color different from the first color to the vehicle, wherein the mechanical mask tool prevents the second paint from being applied to a portion of the vehicle that is to have the first color;
robotically repositioning the mechanical mask tool away from the vehicle;
curing the second paint;
removing second paint on the mechanical mask tool from the mechanical mask tool; and
reusing the mechanical mask tool for painting another vehicle.
